(19) United States
(12) Patent Application Publication
(10) Pub. No.: US 2020/0154094 A1
(43) Pub. Date: May 14, 2020

(54) STEREOSCOPIC IMAGING APPARATUS FOR USE IN CONFINED SPACES

(71) Applicant: Titan Medical Inc., Toronto (CA)

(72) Inventors: Evan Rittenhouse Jones, Levittown, NY (US); Maxime Blain, Rosedale, NY (US); Christopher Dean Smith, Shirley, NY (US)

(21) Appl. No.: 16/186,234

(22) Filed: Nov. 9, 2018

(51) Int. Cl. H04N 13/25; H04N 13/296; H04N 13/275

(52) U.S. Cl. CPC H04N 13/25; H04N 13/275; H04N 13/296

(57) ABSTRACT

In accordance with some embodiments, a stereoscopic imaging apparatus includes a tubular housing configured to be inserted into a confined space and including a bore there through. The apparatus also includes first and second image sensors adjacently mounted on a common sensor circuit substrate sized to be received within the bore, each image sensor including light sensitive elements on a face oriented to capture respective images of an object field from different perspective viewpoints for generating 3D image data. The apparatus includes processing circuit substrates each including processing circuitry for processing signals from the image sensors and sized so as to correspond to size of the sensor circuit substrate. The circuit substrates are connected via flexible interconnects carrying signals between the processing circuitry and facilitating folding of the circuit substrates in back-to-back configuration such that each successive circuit substrate is stacked axially behind preceding circuit substrate within the bore.

### BACKGROUND

### 1. Field

This disclosure relates generally to stereoscopic imaging and more particularly to arrangements for accommodating imaging and processing elements within a housing of a stereoscopic imaging apparatus that is suitable for imaging within a confined space.

### 2. Description of Related Art

Small format image sensors capable of generating high resolution video signals are now available at low cost. For example 1/7 inch (<4 millimeter) sensors capable of producing full HD video are now available. A pair of 1/7 inch image sensors may be adjacently disposed to capture images from differing perspective viewpoints for generating 3D image information while being sufficiently small to fit within a 10 millimeter diameter tubular bore. The image signals generated by CMOS image sensors are however generally of low signal level and would thus be susceptible to interference if transmitted via cable to a distally located host system. Image signals thus generally require processing at or very close to the image sensors, prior to transmission to a host system.

There remains a need for processing circuitry that has a size and aspect commensurate with the size of small format image sensors for imaging in confined spaces.

### SUMMARY

In accordance with some embodiments, there is provided a stereoscopic imaging apparatus. The apparatus includes a tubular housing configured to be inserted into a confined space, the tubular housing including a bore extending through the housing. The apparatus also includes first and second image sensors adjacently mounted on a common sensor circuit substrate sized to be received within the bore, each image sensor including a plurality of light sensitive elements on a face configured to capture respective images of an object field from different perspective viewpoints to generate image data including three-dimensional information. The apparatus further includes a plurality of processing circuit substrates each including image signal processing circuitry, each processing circuit substrate sized to generally correspond to a size of the sensor circuit substrate, the image signal processing circuitry configured to process signals produced by the image sensors to generate an image data stream at an output on one of the processing circuit substrates, the image data stream configured to be transmitted to a host system. The sensor circuit substrate and plurality of processing circuit substrates are connected via flexible interconnects configured to carry signals between image signal processing circuitry on each of the processing circuit substrates, the flexible interconnects facilitating folding of the circuit substrates in back-to-back configuration in which each successive circuit substrate is stacked axially behind a preceding circuit substrate within the bore of the tubular housing.

The sensor circuit substrate and plurality of processing circuit substrates may be connected end-to-end via the flexible interconnects to facilitate folding of the processing circuit substrates in back-to-back z-fold configuration.

Each of the image sensors may include imaging optics disposed in front of the respective faces of each of the image sensors and configured to capture light from the object field to form an image on the respective image sensor.

The sensor circuit substrate may be mounted at an angle within the bore of the tubular housing to cause the respective faces of the image sensors to be oriented at an angle to a longitudinal axis of the bore to capture light from an off-axis object field.

The sensor circuit substrate may be pivotally mounted within the bore of the tubular housing to permit the respective faces of the image sensors to be oriented at an angle to a longitudinal axis of the bore to capture light from an off-axis object field.

The apparatus may include an actuator disposed within the bore and configured to cause the pivoting movement of the sensor circuit substrate over a range of angles with respect to the longitudinal axis.

The range of angles may include angles of between about 0° and about 30° with respect to the longitudinal axis.

The actuator may include one of a linear piezoelectric actuator, a rotary piezoelectric motor, or a control link.

The sensor circuit substrate may be mounted within the bore such that the respective faces of the image sensors are oriented substantially perpendicular to a longitudinal axis of the bore and the apparatus may further include at least one beam steering element responsive to a control signal, the beam steering element configured to cause changes to the optical properties to permit selectively changing the angle of the object field relative to the longitudinal axis.

The sensor circuit substrate may be mounted within the bore such that the respective faces of the image sensors are oriented substantially perpendicular to a longitudinal axis of the bore and the apparatus may further include at least one prism disposed at the end of the bore, the at least one prism configured to capture light from an object field oriented at an angle to the longitudinal axis and to direct the light onto the respective faces of the image sensors.

The image signal processing circuitry may be configured to produce a single data stream representing images captured by each of the image sensors and the output may include a single coaxial connector disposed on one of the plurality of processing circuit substrates distally located with respect to the sensor circuit substrate.

The image signal processing circuitry may be configured to separately process image signals from each of the image sensors to produce first and second data streams, each data stream representing images captured by one of the image sensors and the output may include first and second coaxial connectors disposed on one of the plurality of processing circuit substrates distally located with respect to the sensor circuit substrate.

The tubular housing may be attached to a distal end of an elongate sheath including a bore extending through the sheath and the output may be connected to a cable extending along the bore of the elongate sheath for connection to the host system.

The elongate sheath may include a flexible articulating portion which when actuated by the host system facilitates movement of the tubular housing within the confined space.

The apparatus may include a plurality of optical fibers extending through the bore of the elongate sheath and the bore of the tubular housing and terminating at the end of the tubular housing, the plurality of optical fibers configured to channel light from a distally located light source for illuminating the object field.

The sensor circuit substrate and processing circuit substrates may be sized to occupy a central portion of the bore and the plurality of optical fibers may be routed through a peripheral portion of the bore with respect to the circuit substrates.

The tubular housing may have a generally circular cross section.

The bore of the tubular housing may have a diameter of about 10 millimeters. The stereoscopic imaging apparatus may be used in a robotic surgery system. The tubular housing can be configured to be inserted into a body cavity of a patient.

The image signal processing circuitry may include circuitry configured to provide image processing functions for conditioning the image signals produced by the respective image sensors and circuitry configured to convert the conditioned image signals into a data stream suitable for transmission to the host system.

In accordance with some embodiments, there is provided a stereoscopic imaging apparatus including a tubular housing configured to be inserted into a confined space, the tubular housing including a bore extending through the housing, at least a portion of the tubular housing being bendable. The apparatus also includes first and second image sensors adjacently mounted on a common sensor circuit substrate sized to be received within the bore, each image sensor including a plurality of light sensitive elements on a face oriented to capture respective images of an object field from different perspective viewpoints to generate image data including three-dimensional information. The apparatus further includes a plurality of processing circuit substrates each including image signal processing circuitry, each of the processing circuit substrates having extents generally corresponding to an extent the sensor circuit substrate, the image signal processing circuitry configured to process signals produced by the image sensors to generate an image data stream at an output on one of the processing circuit substrates to be transmitted to a host system. The sensor circuit substrate and plurality of processing circuit substrates are connected via flexible interconnects configured to carry signals between image signal processing circuitry on each of the processing circuit substrates, the flexible interconnects facilitating bending of the processing circuit substrates within the bore of the tubular housing.

Other aspects and features will become apparent to those ordinarily skilled in the art upon review of the following description of specific disclosed embodiments in conjunction with the accompanying figures.

### BRIEF DESCRIPTION OF THE DRAWINGS

In drawings which illustrate disclosed embodiments,

FIG. 1 is a partially cut away front perspective view of a stereoscopic imaging apparatus according to a first disclosed embodiment;

FIG. 2 is a rear perspective view of a portion of the stereoscopic imaging apparatus shown in FIG. 1;

FIG. 3 is a perspective view of an imaging scope including the stereoscopic imaging apparatus shown in FIG. 1;

FIG. 4 is a side view of a stereoscopic imaging apparatus in accordance with another disclosed embodiment;

FIG. 5 is a further side view of the stereoscopic imaging apparatus shown in FIG. 4 with an image sensor circuit substrate in a deployed position;

FIG. 6 is a side view of a stereoscopic imaging apparatus in accordance with another disclosed embodiment;

FIG. 7 is a perspective view of a sensor circuit substrate and plurality of circuit substrates of the stereoscopic imaging apparatus shown in FIG. 1 as fabricated; and

FIG. 8 is rear perspective view of another embodiment of a stereoscopic imaging apparatus.

### DETAILED DESCRIPTION

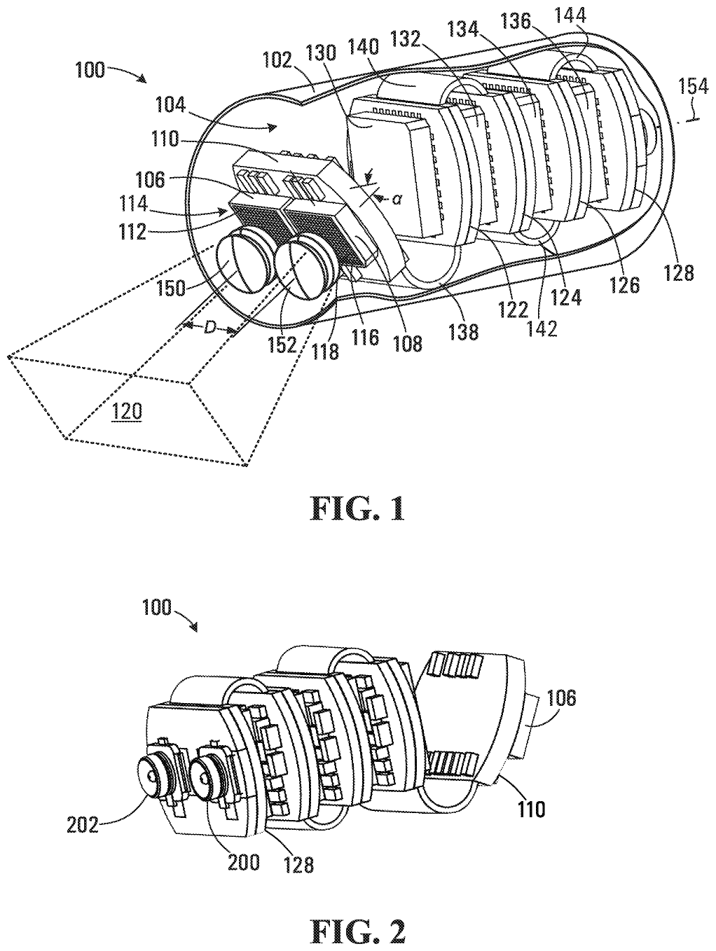

Referring to FIG. 1, a stereoscopic imaging apparatus according to a first disclosed embodiment is shown generally at 100. The apparatus 100 includes a tubular housing 102 having a bore 104 extending through the housing. The tubular housing 102 is configured for insertion into a confined space, such as a body cavity of a patient. In the embodiment shown, the tubular housing 102 has a generally circular cross section and in one embodiment may have a diameter of about 10 millimeters.

The apparatus 100 also includes first and second image sensors 106 and 108, adjacently mounted on a common sensor circuit board or substrate 110 sized to be received within the bore 104. The image sensor 106 includes a plurality of light sensitive elements 112 on a face 114, while the image sensor 108 includes a plurality of light sensitive elements 116 on a face 118. The faces 114 and 118 are oriented to capture respective images of an object field 120 from different perspective viewpoints for generating image data including three-dimensional information. Each of the image sensors 106 and 108 have respective imaging optics 150, 152 disposed in front of the faces 114 and 118 and operably configured to capture light from the object field 120 to form an image on the respective image sensors. In this embodiment, the image sensors 106 and 108 are mounted on the sensor circuit substrate 110 such that the faces 114 and 118 are in a common plane, but spaced apart by an inter sensor center-center spacing dimension D. The image sensors 106 and 108 may be implemented using CMOS image sensors, which generally have lower cost and lower operating power requirements than charge-coupled device sensors (CCD).

The apparatus 100 further includes a plurality of processing circuit boards or substrates 122, 124, 126, and 128 each carrying image signal processing circuitry. In the embodiment shown in FIG. 1, the circuit substrates 122, 124, 126, and 128 have extents that generally correspond to the sensor circuit substrate 110 and fit within the bore when oriented perpendicular to a longitudinal axis 154. In some cases, the circuit substrates are shaped and/or sized to substantially match the shape and/or size of the sensor circuit substrate. In the embodiment shown, each of the plurality of circuit substrates 122-128 includes image signal processing circuitry in the form of respective integrated circuits 130, 132, 134, and 136 configured to provide image processing functions for conditioning the image signals produced by the respective image sensors 106 and 108 and converting the conditioned image signals into a data stream for transmission back to a host system. In one embodiment, the integrated circuits 130, 132, 134, and 136 may be implemented using an application-specific integrated circuit (ASIC), field-programmable gate array (FPGA), or other large scale integrated circuit.

Referring to FIG. 2, the apparatus 100 is shown in a rear perspective view with the tubular housing 102 omitted. The circuit substrate 128 has output connectors 200 and 202 for connection to respective transmission cables for transmitting image data streams associated with the image sensors 106 and 108 back to the host system (not shown in FIGS. 1 and 2). In the embodiment shown, the output connectors 200 and 202 are implemented as coaxial cable connectors operable to transmit a 3G serial digital interface (SDI) serial data stream through a coaxial cable to the host system. The processing circuitry on the circuit substrates 122-128 thus formats the image data into serial data streams for transmission.

The sensor circuit substrate 110 and plurality of circuit substrates 122-128 are connected end-to-end via flexible interconnects 138, 140, 142, and 144 that carry signals between image signal processing circuitry on each of the processing circuit substrates 122-128. The flexible interconnects 138-144 also facilitate folding of the circuit substrates 122-128 in a back-to-back z-fold configuration such that each successive circuit substrate is stacked axially behind the preceding circuit substrate within the bore 104 of the tubular housing 102. The circuit substrates 122-128 can be arranged in planes that are parallel to each other. Centers of each of the circuit substrates can be aligned in a straight line.

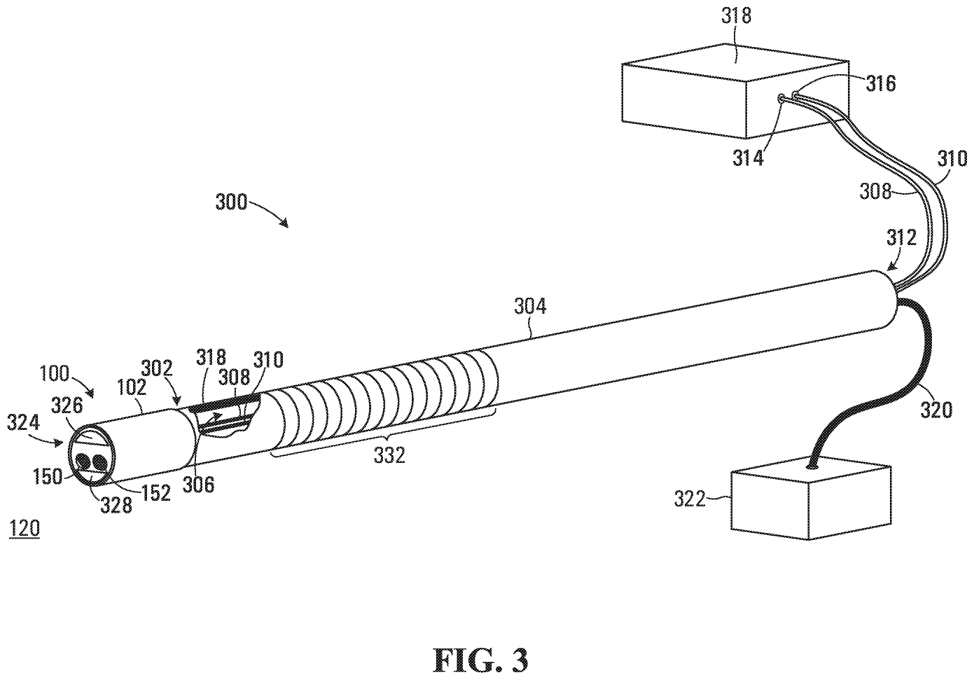

Referring to FIG. 3, an imaging scope for insertion into a confined space is shown generally at 300. In the embodiment shown, the tubular housing 102 may be attached to a distal end 302 of an elongate sheath 304 having a bore 306 extending through the sheath. The apparatus 100 and elongate sheath 304 together make up the imaging scope 300. The imaging scope 300 includes first and second electrical cables 308 and 310 extending through the bore 306 and connected to the output connectors 200 and 202 that carry the image signals along the elongate sheath 304 to a proximal end 312 of the sheath. The cables 308 and 310 are connected to inputs 314 and 316 of a host system 318.

In this embodiment, the apparatus 100 also includes a plurality of optical fibers 320 extending through the bore 306 of the elongate sheath 304 and the bore 104 of the tubular housing 102. The optical fibers receive light from a distally located illumination source 322, which is channeled along the optical fibers to a distal end 324 of the tubular housing 102. The optical fibers 320 may be routed peripherally within the tubular housing 102 of the apparatus 100 and terminate at the distal end 324 at upper and lower illumination windows 326 and 328 for illuminating the object field 120. The sensor circuit substrate 110 and processing circuit substrates 122-128 may be sized to occupy a central portion of the bore 104 and the plurality of optical fibers 320 may be routed through a peripheral portion of the bore with respect to the circuit substrates.

In this embodiment, the sheath 304 also includes a flexible articulating portion 332 which when actuated by the host system 318 facilitates movement of the tubular housing 102 within the confined space to orient the imaging optics 150 and 152 to illuminate and view a desired portion of the object field 120. In one embodiment, the flexible articulating portion 332 may be configured generally as disclosed in commonly owned Patent Cooperation Treaty patent publication WO2014201538, filed on Dec. 20, 2013 and incorporated herein by reference in its entirety.

Referring back to FIG. 1, while the circuit substrates 122-128 are disposed general perpendicular to the longitudinal axis 154 through the bore 104, the sensor circuit substrate 110 is mounted at an angle α of about 30° with respect to the longitudinal axis 154. The resulting angled image sensors 106 and 108 capture light from an object field 120 that is off-axis with respect to the longitudinal axis 154. The off-axis object field 120 may be advantageous in embodiments such as robotic surgery where it is desirable to deploy the apparatus 100 to prevent encroaching on the working volume of surgical instruments introduced into the confined space.

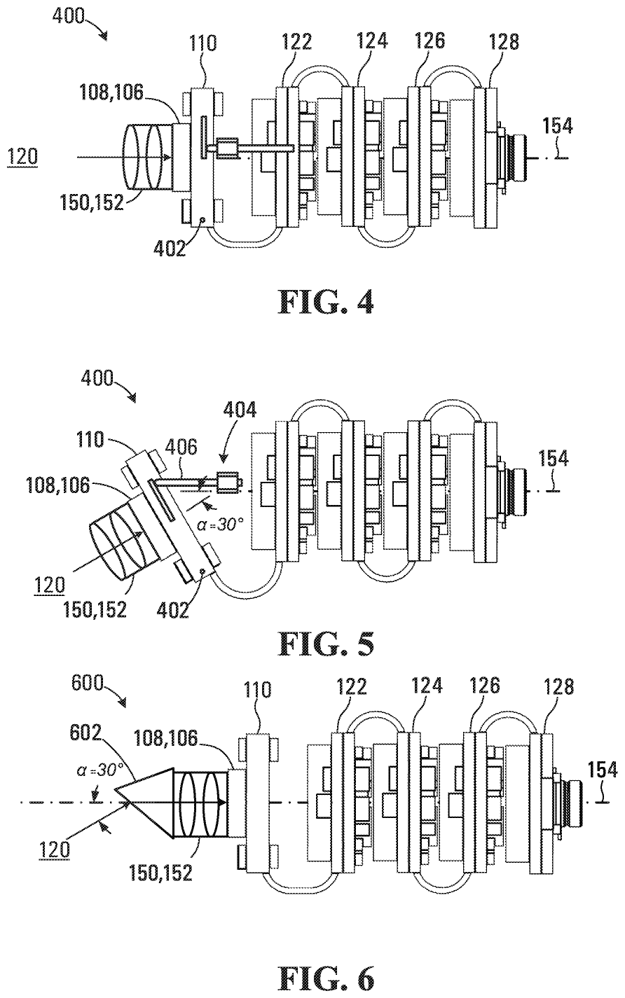

Referring to FIG. 4, another embodiment of a stereoscopic imaging apparatus is shown in cross section generally at 400. The apparatus 400 includes the sensor circuit substrate 110, image sensors 106 and 108, the imaging optics 150 and 152, and the circuit substrates 122-128 configured generally as shown in FIG. 1. However in this embodiment the sensor circuit substrate 110 is mounted for pivoting movement about an axis 402 (extending into the page). The apparatus 400 also includes an actuator 404 operably configured to cause a rod 406 to advance or retract to cause angular movement of the sensor circuit substrate 110 about the axis 402. As shown in FIG. 5, the sensor circuit substrate 110 of the apparatus 400 has been pivoted to a fully deployed position at an angle of about 30° to the longitudinal axis 154.

In one embodiment, the actuator 404 may be implemented using a linear piezoelectric motor that receives a drive signal via a cable (not shown) extending through the bore 104. The drive signal may be generated at the host system 318 to cause the rod 406 to move forward or backward in steps, thus facilitating positioning of the sensor over a range of angles. This has the advantage of being able to orient the image sensors 106 and 108 over any of a range of angles a to the longitudinal axis 154 by generating an appropriate drive signal to move the actuator 404 through a pre-determined number of steps. In one embodiment, the range of angles a may include angles of between about 0° to about 30° with respect to the longitudinal axis 154.

In other embodiments, the actuator may be implemented using any other miniature actuator such as a rotary piezoelectric motor or a SQUIGGLE motor (available from New Scale Technologies, Inc. of NY). In another embodiment, movement of the sensor circuit substrate 110 may be actuated by pushing and/or pulling on a control link running through the bore 104 (and through the elongate sheath 304, if provided).

Referring to FIG. 6, another embodiment of a stereoscopic imaging apparatus is shown in cross section generally at 600. The apparatus 600 includes the sensor circuit substrate 110, image sensors 106 and 108, the imaging optics 150 and 152, and the circuit substrates 122-128 configured generally as shown in FIG. 1. The sensor circuit substrate 110 is mounted within the bore 104 such that the respective faces of the image sensors 106 and 108 are oriented substantially perpendicular to the longitudinal axis 154. In this embodiment, the apparatus 600 further includes a prism 602 disposed in front of the imaging optics 150 and 152. The prism 602 has prism angles selected to cause light to be captured from an object field 120 oriented at about 30° off-axis with respect to the longitudinal axis 154. Light captured from the off-axis object field 120 is diverted by the prism 602 and becomes substantially aligned with the longitudinal axis 154 prior to impinging onto the faces of the image sensors 106 and 108.

In other embodiments, an electrically controllable beam steering element may be implemented in place of the prism 602, facilitating control of the deviation angle a in response to a control signal generated by the host system 318. As an example, the prism may be implemented using a beam steering element such as the TP-12-16 liquid prism or MR-15-30 tunable mirror available from Optotune Switzerland AG.

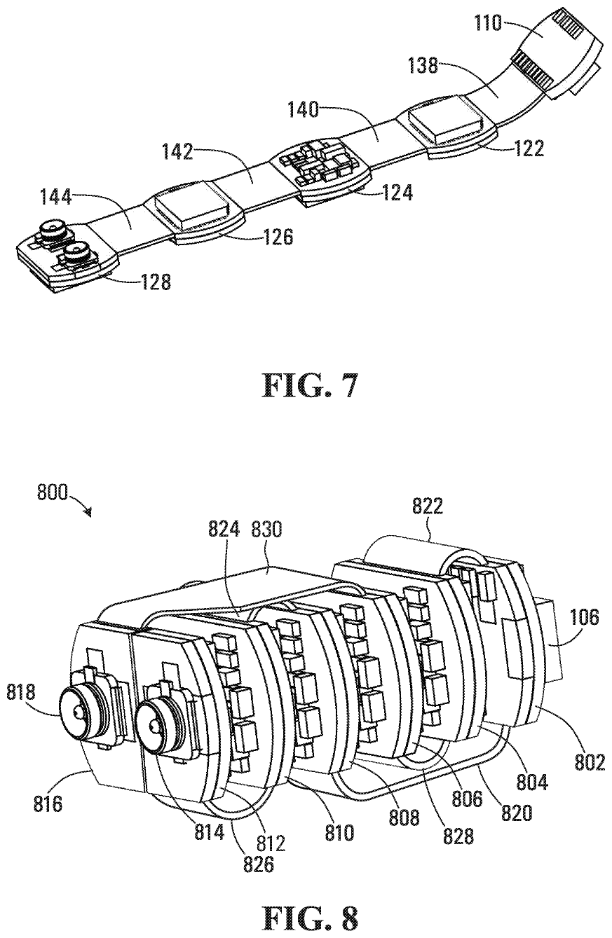

Referring to FIG. 7, the sensor circuit substrate 110 and the plurality of circuit substrates 122-128 may be fabricated in a strip as shown and subsequently folded back-to-back at the flexible interconnects 138-144 for insertion into the bore 104 of the tubular housing 102 as shown in FIG. 1. In this embodiment, the sensor circuit substrate 110 and plurality of processing circuit substrates 122-128 are connected end-to-end via the flexible interconnects 138-144 and thus signals from each of the sensors 106 and 108 must be propagated through each of the circuit substrates 122-128 before reaching the outputs.

In an alternative embodiment, the plurality of circuit substrates 122-128 may still be fabricated in a strip generally as shown in FIG. 7 but rather than being folded may be received within the tubular housing 102 in a lengthwise layout. This configuration would allow the diameter of the tubular housing 102 to be reduced as the image processing circuitry would be spaced apart along a length of the tubular housing 102 (through the plurality of circuit substrates 122-128). This lengthwise layout may also allow the plurality of circuit substrates 122-128 to be disposed within a flexible or bendable portion of the housing (not shown) allowing the image processing circuitry to flex at the flexible interconnects 138-144 when the housing flexes.

Referring back to FIG. 1, image data signals produced at each of the image sensors 106 and 108 are passed via the sensor circuit substrate 110 and flexible interconnect 138 to the circuit substrate 122 and then via the flexible interconnect 140 to the circuit substrate 124. In one embodiment, the integrated circuits 130 and 132 on the circuit substrates 122 and 124 perform signal processing and data formatting functions on the image data received from one of the sensors (for example, the sensor 106) while the image data from the other image sensor 108 is simply passed through the circuit substrates 122 and 124. Similarly, the integrated circuits 134 and 136 on the circuit substrates 126 and 128 may perform signal processing and data formatting functions on the image data received from the sensor 108 while the image data from the image sensor 106 is simply passed through to the output 200. In other embodiments, the order of processing may differ, for example signal processing for the image sensor 106 may be performed on the integrated circuit 130 and signal processing for the image sensor 108 on the integrated circuit 132.

Referring to FIG. 8, another embodiment of a stereoscopic imaging apparatus is shown generally at 800. The apparatus 800 includes a sensor circuit substrate 802 on which the image sensors 106 and 108 are mounted as shown in FIG. 1. However, in this embodiment the sensor circuit substrate 802 has a first flexible interconnect 820 extending from a lower edge of the sensor circuit substrate 802 and a second flexible interconnect 822 extending from an upper edge of the sensor circuit substrate 802. Further processing circuit substrates 804, 806, 808 and 810 are disposed back-to-back in a folded configuration. The apparatus 800 further includes an output circuit substrate 812 having an output connector 814 and an output circuit substrate 816 having an output connector 818.

Image data received from the sensor 106 is transmitted via the first flexible interconnect 820 to the circuit substrate 808 for processing and then via a flexible interconnect 824 to the circuit substrate 810 for further processing. The circuit substrates 808 and 810 are disposed back-to-back and behind the circuit substrate 806. The processed image data is then transmitted via the flexible interconnect 826 to the output circuit substrate 812 where the output signal is made available at the output connector 814. Similarly, image data received from the sensor 108 is transmitted via the second flexible interconnect 822 to the circuit substrate 804 for processing and then via a flexible interconnect 828 to the circuit substrate 806 for further processing. The circuit substrates 804 and 806 are disposed back-to-back and nested between the sensor circuit substrate 802 and the circuit substrate 808. The processed image data is then transmitted via the flexible interconnect 830 to the output circuit substrate 816 where the output signal is made available at the output connector 818.

One advantage of the alternative arrangement of circuit substrates in the apparatus 800 is that image data signals produced by the sensor 106 are not routed through the same circuit substrates on which processing of signals from the image sensor 108 is being performed. Similarly, image data signals produced by the sensor 108 are not routed through the same circuit substrates on which processing of signals from the image sensor 106 is being performed. If image signals from the image sensor 106 and image sensor 108 are routed in close proximity on a circuit substrate, there is an increased possibility of interference and crosstalk between the signals. Image signals from the sensors 106 and 108 are particularly susceptible to interference due to having a relatively low signal level. Additionally, if image data signals produced by both of the sensors 106 and 108 were to be routed through the same circuit substrate, the layout of the circuit substrate may require tiny vias (vertical interconnect accesses) between layers. The need for vias adds to the fabrication complexity associated with the substrate.

In the apparatus 800, the image signals from the image sensor 106 go through signal conditioning and data formatting on the circuit substrates 808 and 810, following which the processed signal is transmitted to the output connector 814 via the flexible interconnect 826. The processed signal is generally less susceptible to interference and crosstalk. The image signals from the image sensor 108 go through signal conditioning and data formatting on the circuit substrates 804 and 806, following which the processed signal is transmitted to the output connector 818 via the flexible interconnect 830. In the apparatus 800, the circuit substrates are still back to back and have a similar overall extent within the bore 104 of the tubular housing 102, but provide for improved separation between the processing paths for the respective image sensors 106 and 108.

In the embodiments described above, image data produced by each image sensor 106 and 108 is processed and formatted into its own individual data stream at the respective output connectors 200, 202 or 814, 818. The image signal processing circuitry is configured to separately process image signals from each of the image sensors 106 and 108 to produce first and second data streams at the respective output connectors 200, 202 or 814, 818. Each data stream thus represents images captured by one of the image sensors 106 and 108. The first and second coaxial connectors are thus disposed on the circuit substrate distally located with respect to the sensor circuit substrate 110, 802. Transmission of these signals via separate cables 308 and 310 between the apparatus 100, 800 and the host system 318 facilitates a high transmission data rate for high resolution video imaging.

In other embodiments, the two data streams may be combined into a single data stream and made available at a single output for transmission via a single cable to the host system 318. The image signal processing circuitry may be configured to produce a single data stream combining images captured by each of the image sensors 106 and 108 and a single output connector may be provided on the output circuit substrate. A suitable data transmission protocol for combining two image data streams from stereoscopic image sensors is disclosed in commonly owned patent publication US 20180054605 filed on Aug. 15, 2017, and incorporated herein by reference in its entirety.

The above disclosed embodiments are able to take full advantage of small image sensor formats now available to provide for stereoscopic imaging within a small bore housing. The disclosed arrangement, size, and aspect of the circuit substrates makes effective use of a volume within the housing that is available for accommodating processing circuitry. The disclosed arrangements further facilitate pivoting of the sensors to provide off-axis imaging of the object field.

While specific embodiments have been described and illustrated, such embodiments should be considered illustrative only and not as limiting the disclosed embodiments as construed in accordance with the accompanying claims.

What is claimed is:

1. A stereoscopic imaging apparatus comprising:
a tubular housing configured to be inserted into a confined space, the tubular housing including a bore extending through the housing;
first and second image sensors adjacently mounted on a common sensor circuit substrate sized to be received within the bore, each image sensor including a plurality of light sensitive elements on a face oriented to capture respective images of an object field from different perspective viewpoints and to generate image data including three-dimensional (3D) information;
a plurality of processing circuit substrates each including image signal processing circuitry, each processing circuit substrate sized to generally correspond to a size of the sensor circuit substrate, the image signal processing circuitry configured to process signals produced by the image sensors to generate an image data stream at an output on one of the processing circuit substrates, the image data stream configured to be transmitted to a host system; and
wherein the sensor circuit substrate and plurality of processing circuit substrates are connected via flexible interconnects configured to carry signals between image signal processing circuitry on each of the processing circuit substrates, the flexible interconnects facilitating folding of the processing circuit substrates in back-to-back configuration in which each successive circuit substrate is stacked axially behind a preceding circuit substrate within the bore of the tubular housing.

2. The apparatus of claim 1 wherein the sensor circuit substrate and plurality of processing circuit substrates are connected end-to-end via the flexible interconnects to facilitate folding of the processing circuit substrates in back-to-back z-fold configuration.

3. The apparatus of claim 1 wherein each of the image sensors includes imaging optics disposed in front of the respective faces of each of the image sensors and configured to capture light from the object field to form an image on the respective image sensor.

4. The apparatus of claim 3 wherein the sensor circuit substrate is mounted at an angle within the bore of the tubular housing to cause the respective faces of the image sensors to be oriented at an angle to a longitudinal axis of the bore to capture light from an off-axis object field.

5. The apparatus of claim 3 wherein the sensor circuit substrate is pivotally mounted within the bore of the tubular housing to permit the respective faces of the image sensors to be oriented at an angle to a longitudinal axis of the bore to capture light from an off-axis object field.

6. The apparatus of claim 5 further comprising an actuator disposed within the bore and configured to cause the pivoting movement of the sensor circuit substrate over a range of angles with respect to the longitudinal axis.

7. The apparatus of claim 6 wherein the range of angles comprise angles of between about 0° and about 30° with respect to the longitudinal axis.

8. The apparatus of claim 7 wherein the actuator comprises one of a linear piezoelectric actuator, a rotary piezoelectric motor, or a control link.

9. The apparatus of claim 3 wherein the sensor circuit substrate is mounted within the bore such that the respective faces of the image sensors are oriented substantially perpendicular to a longitudinal axis of the bore, and wherein the apparatus further comprises at least one beam steering element responsive to a control signal, the beam steering element configured to cause changes to the optical properties to permit selectively changing the angle of the object field relative to the longitudinal axis.

10. The apparatus of claim 3 wherein the sensor circuit substrate is mounted within the bore such that the respective faces of the image sensors are oriented substantially perpendicular to a longitudinal axis of the bore, and wherein the apparatus further comprises at least one prism disposed at the end of the bore, the at least one prism configured to capture light from an object field oriented at an angle to the longitudinal axis and to direct the light onto the respective faces of the image sensors.

11. The apparatus of claim 1 wherein the image signal processing circuitry is configured to produce a single data stream representing images captured by each of the image sensors, and wherein the output comprises a single coaxial connector disposed on one of the plurality of processing circuit substrates distally located with respect to the sensor circuit substrate.

12. The apparatus of claim 1 wherein the image signal processing circuitry is configured to separately process image signals from each of the image sensors to produce first and second data streams, each data stream representing images captured by one of the image sensors, and wherein the output comprises first and second coaxial connectors disposed on one of the plurality of processing circuit substrates distally located with respect to the sensor circuit substrate.

13. The apparatus of claim 1 wherein the tubular housing is attached to a distal end of an elongate sheath including a bore extending through the sheath, and wherein the output is connected to a cable extending along the bore of the elongate sheath for connection to the host system.

14. The apparatus of claim 13 wherein the elongate sheath comprises a flexible articulating portion which, when actuated by the host system, facilitates movement of the tubular housing within the confined space.

15. The apparatus of claim 14 further comprising a plurality of optical fibers extending through the bore of the elongate sheath and the bore of the tubular housing and terminating at the end of the tubular housing, the plurality of optical fibers configured to channel light from a distally located light source for illuminating the object field.

16. The apparatus of claim 15 wherein the sensor circuit substrate and processing circuit substrates are sized to occupy a central portion of the bore, and wherein the plurality of optical fibers are routed through a peripheral portion of the bore with respect to the circuit substrates.

17. The apparatus of claim 1 wherein the tubular housing includes a generally circular cross section.

18. The apparatus of claim 17 wherein the bore of the tubular housing has a diameter of about 10 millimeters.

19. A robotic surgery system comprising the apparatus of claim 1 wherein the tubular housing is configured to be inserted into a body cavity of a patient.

20. The apparatus of claim 1 wherein the image signal processing circuitry comprises circuitry configured to provide image processing functions for conditioning the image signals produced by the respective image sensors and circuitry configured to convert the conditioned image signals into a data stream suitable for transmission to the host system.

21. A stereoscopic imaging apparatus comprising:
a tubular housing configured to be inserted into a confined space, the tubular housing including a bore extending through the housing, at least a portion of the tubular housing being bendable;
first and second image sensors adjacently mounted on a common sensor circuit substrate sized to be received within the bore, each image sensor including a plurality of light sensitive elements on a face oriented to capture respective images of an object field from different perspective viewpoints to generate image data including three-dimensional (3D) information;
a plurality of processing circuit substrates each including image signal processing circuitry, each of the processing circuit substrates having extents generally corresponding to an extent of the sensor circuit substrate, the image signal processing circuitry configured to process signals produced by the image sensors to generate an image data stream at an output on one of the processing circuit substrates to be transmitted to a host system; and
wherein the sensor circuit substrate and plurality of processing circuit substrates are connected via flexible interconnects configured to carry signals between image signal processing circuitry on each of the processing circuit substrates, the flexible interconnects facilitating bending of the processing circuit substrates within the bore of the tubular housing.
